(19) United States
(12) Patent Application Publication
(10) Pub. No.: US 2023/0083620 A1
(43) Pub. Date: Mar. 16, 2023

(54) OVERMOLDED AIR STRUT TOP CAP WITH METAL REINFORCEMENTS

(71) Applicant: Continental Automotive Systems, Inc., Auburn Hills, MI (US)

(72) Inventors: Garrett Mark Pniewski, Bloomfield Hills, MI (US); Petr Malik, Rochester Hills, MI (US); Joseph G. Jerisk, Burton, MI (US)

(73) Assignee: Continental Automotive Systems, Inc., Auburn Hills, MI (US)

(21) Appl. No.: 17/889,588

(22) Filed: Aug. 17, 2022

Related U.S. Application Data
(60) Provisional application No. 63/261,283, filed on Sep. 16, 2021.

(51) Int. Cl. B60G 15/12

(52) U.S. Cl. CPC B60G 15/12; B60G 2202/32; B60G 2202/152; B60G 2204/43; B60G 2204/126; B60G 2206/424; B60G 2206/81012

(57) ABSTRACT

An air spring strut assembly includes a top cap with a metal flange overmolded within a plastic overmold housing. The metal flange carries structural loads through the top cap and the plastic overmold housing includes non-load bearing complex shapes ands surfaces. A shock absorber and bellows are attached to the top cap to complete the air spring strut assembly.

### CROSS-REFERENCE TO RELATED APPLICATIONS

This application claims priority to U.S. Provisional Application No. 63/261,283 filed on Sep. 16, 2021.

### TECHNICAL FIELD

The present disclosure relates to a top cap for an air spring strut and more particularly to a top cap with overmolded metal support features.

### BACKGROUND

An air spring strut provides spring cushioning and damping for a motor vehicle suspension system. An air strut includes an air spring and an integrated shock absorber. The air spring includes a bellow clamped between a top cap and a lower portion attached to the shock absorber. The top cap is attached to a frame member of the motor vehicle and the shock absorber is attached to a suspension member. Loads encountered during vehicle operation are transferred through the top cap to the frame member of the vehicle. Moreover, the top cap includes features and complex shapes that provide for attachment of the shock absorber, bellows and other features and structures of the air strut. Accordingly, the top cap is required to be formed from a material that can accommodate the significant loads encountered during vehicle operation while also providing the features required for assembly of the air spring strut.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An air spring strut for a motor vehicle according to one disclosed example embodiment includes, among other possible things, a shock absorber, a top cap with an overmolded metal flange extending from a plastic overmold housing, the metal flange configured for attachment to a frame member of a motor vehicle and the plastic overmold housing configured for receiving a damper bushing, and a bellows including a first end clamped to the plastic overmold housing of the top cap and a second end attached to a portion of the shock absorber, the bellows defining a working space filled with air and forming a rolling fold that rolls on the top cap and the shock absorber.

In a further embodiment of the foregoing air spring strut, the plastic overmold housing defines a top cavity, a bottom cavity and an opening extending therebetween for a piston rod of the shock absorber.

In a further embodiment of any of the foregoing air spring struts, a center portion of the metal flange is disposed within the plastic overmold housing between the top cavity and the bottom cavity.

In a further embodiment of any of the foregoing air spring struts, an outer portion of the metal flange extends outward from the center portion and outward from the plastic overmold housing.

In a further embodiment of any of the foregoing air spring struts, the center portion of the metal flange includes at least one opening and plastic material of the plastic overmold housing is disposed within the at least one opening for securing the metal flange within the plastic overmold housing.

In a further embodiment of any of the foregoing air spring struts, the bottom cavity is configured to receive and hold a bumper to limit movement and absorb energy from the shock absorber.

In a further embodiment of any of the foregoing air spring struts, the top cavity includes an integrally molded inner groove for receiving a retaining ring to secure a closure cap to the top cap.

In a further embodiment of any of the foregoing air spring struts, the metal flange includes a plurality of outwardly extending ribs that extend outward from the plastic overmold housing.

In a further embodiment of any of the foregoing air spring struts, including at least one metal fastening member secured to the metal flange.

In a further embodiment of any of the foregoing air spring struts, a support ring partially overmolded within the plastic overmold housing, the support ring formed from a metal and is disposed radially inward of a crimp surface for the first end of the bellows.

A top cap assembly for an air spring strut according to another example disclosed embodiment, includes, among other possible things, an overmolded metal flange extending outwardly from a plastic overmold housing with the metal flange configured for attachment to a frame member of a motor vehicle and the plastic overmold housing configured for receiving a damper bushing.

In a further embodiment of the foregoing top cap assemblies, the plastic overmold housing defines a top cavity, a bottom cavity and an opening extending therebetween.

In a further embodiment of any of the foregoing top cap assemblies, a center portion of the metal flange is disposed within the plastic overmold housing between the top cavity and the bottom cavity.

In a further embodiment of any of the foregoing top cap assemblies, an outer portion of the metal flange extends outward from the center portion and outward from the plastic overmold housing.

In a further embodiment of any of the foregoing top cap assemblies, the center portion of the metal flange includes at least one opening and plastic material of the plastic overmold housing is disposed within the at least one opening for securing the metal flange within the plastic overmold housing.

A method of assembling an air strut assembly according to another disclosed embodiment includes, among other possible things, forming a metal flange to include attachment features configured for securement to a frame member of a motor vehicle, forming a top cap assembly by overmolding the metal flange into a plastic overmold housing such that features of the metal flange configured for securement to the motor vehicle extend outside of the plastic overmold housing, assembling a shock absorber assembly to the top cap assembly, and assembling a first end of a bellows to the top cap and a second end of the bellows to a portion of the shock absorber, the bellows defining a working space filled with air and forming a rolling fold that rolls on the top cap and the shock absorber.

In a further embodiment of the foregoing method, forming the top cap assembly further includes overmolding a support ring partially within the plastic overmold housing and radially inward of a crimp portion formed of the plastic material of the plastic overmold assembly.

In a further embodiment of any of the foregoing methods, forming the metal flange to include rib portions extending radially outward from a center portion, wherein the attachment features are disposed on the rib portions.

In a further embodiment of any of the foregoing methods, the center portion of the metal flange is formed to include at least one opening and forming the top cap assembly includes overmolding the metal flange such that plastic material of the plastic overmold housing is disposed within the at least one opening for securing the metal flange within the plastic overmold housing.

In a further embodiment of any of the foregoing methods, assembling the shock absorber to the top cap assembling further includes assembling a damper bushing into a top cavity of the top cap and extending a piston rod of the damper through an opening in the top cap into the top cavity and attaching the piston rod to the damper bushing.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a cross-sectional view of an example air spring strut embodiment.

FIG. 2 is a cross-sectional view of an example top cap assembly embodiment.

FIG. 3 is a top perspective view of the example top cap assembly embodiment.

FIG. 4 is a plan view of an example metal flange of the top cap assembly.

FIG. 5 is a cross-sectional view of the example metal flange.

FIG. 6 is a schematic flow diagram of an example method of assembling an air spring strut.

### DETAILED DESCRIPTION

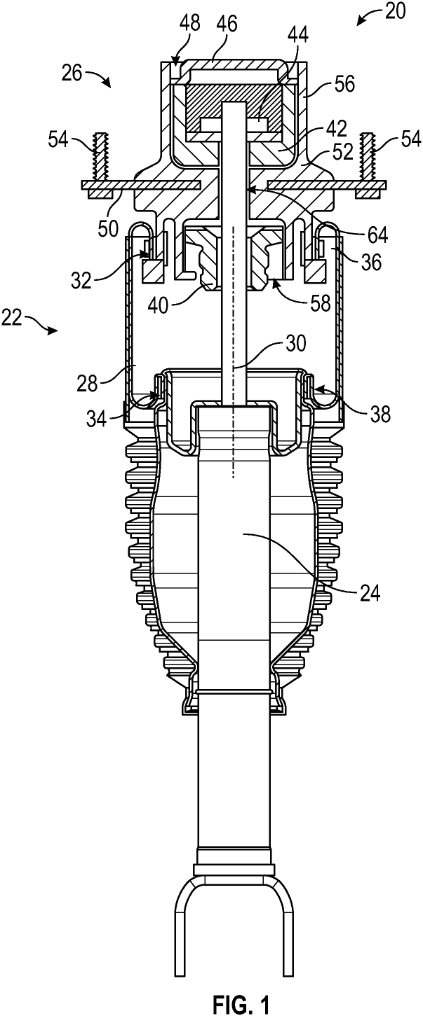

Referring to FIG. 1, an air spring strut is shown in cross-section and generally indicated at 20. The air spring strut 20 includes a top cap 26 with an overmolded metal flange 50 that defines the connection interface to a motor vehicle frame. The metal flange 50 is overmolded into the a plastic overmold housing 52 of the top cap 26 to provide a single integrated part reduces weight while retaining structural durability and strength.

The example air spring strut 20 includes an air spring 22 and shock absorber 24. A bellows 28 includes a first end 32 and a second end 34. The bellows 28 provides a working volume for the air spring 22. The first end 32 of the bellows 28 is secured in an airtight manner to the top cap 26. The second end 34 of the bellows 28 is secured to a portion of the shock absorber 24. An upper clamping ring 36 secures the first end of the bellows 28 to the top cap 26. A lower clamping ring 38 secures the second end 34 of the bellows 28 to the shock absorber 24.

The bellows 28 is embodied in one disclosed example as a double lobe rolling bellow. However, other bellow 28 and air spring configurations could be utilized and are within the contemplation and scope of this disclosure.

A piston rod 30 of the shock absorber 24 extends upward through the top cap 26 into a top cavity 56. In the top cavity 56, the piston rod 30 is secured to a damper bushing 42 by a nut 44. A closure cap 46 is secured over the top cavity 56 by a retaining ring 48.

A jounce bumper 40 is secured within a bottom cavity 58 defined in the top cap 26. An opening 64 through the top cap 26 between the top cavity 56 and the bottom cavity 58 provides an open space for the piston rod 30.

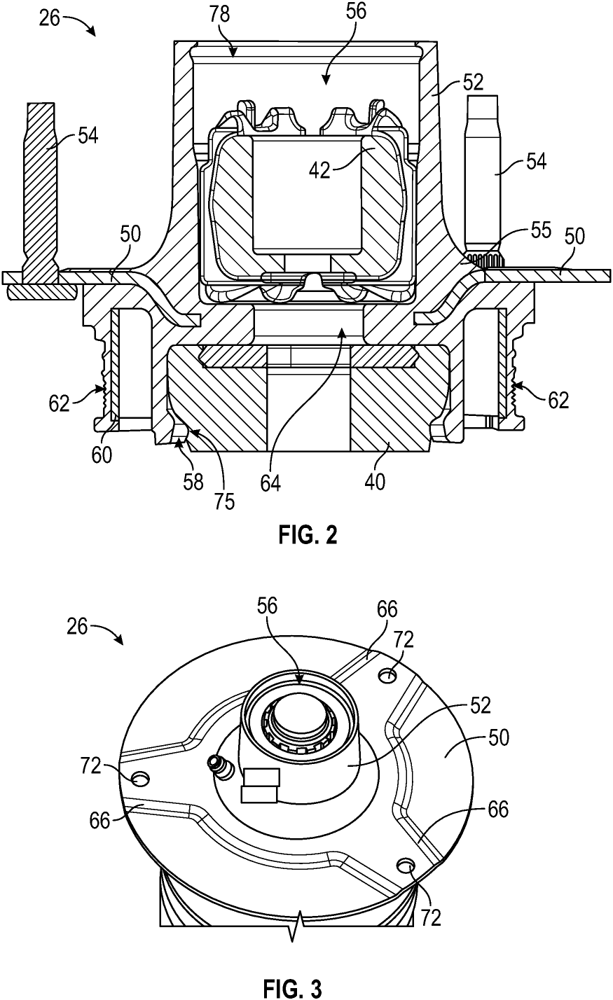

Referring to FIGS. 2 and 3 with continued reference to FIG. 1, the top cap 26 includes the metal flange 50 overmolded into the plastic overmold housing 52. The metal flange 50 is molded into the plastic overmold housing 52 to define mounting features that interface with the vehicle body and/or frame and that define a load path through the air spring strut 20. One or more fastening member may be attached to the metal flange 50 to facilitate mounting depending on vehicle specific configurations. In one disclosed example, threaded studs 54 are press fit into the metal flange 50 to facilitate mounting. Other fastening devices and structures could also be utilized and are within the contemplation and scope of this disclosure.

The plastic overmold housing 52 defines other features that do not require the structural strength of metal. In one disclosed example, the plastic overmold housing 52 defines the top cavity 56 for the damper bushing 42 and a bottom cavity 58 for a jounce bumper 40.

The plastic overmold housing 52 further defines crimp support surfaces 62 that are configured to receive the first end of the bellows 28. A support ring 60 is overmolded into the plastic overmold housing 52 radially inward of the crimp support surfaces 62 to provide structure rigidity. In one disclosed example, the support ring 60 is a continuous metal ring with a thickness and material properties that provide the desired structural characteristics to maintain an air tight seal of the bellows 28. In the disclosed example, the support ring 60 is overmolded in and has an exposed inner side that is not covered with plastic material.

The plastic overmold housing 52 includes the complex, irregular shapes and features that are not efficiently formed using metal processing techniques. The crimp support surfaces 62 include a series of grooves that provide the desired air tightness. Such grooves are time and cost intensive when formed in a metal casting or forging.

Moreover, the configuration of the top cavity 56 and the bottom cavity 58 include features that provide for assembly of the completed air spring strut 20. The top cavity 56 includes an inner groove 78 for the retaining ring 48 used to hold the closure cap 46 in place. The bottom cavity 58 includes an inner tab 75 that holds the bumper 40 in place. Such features are inefficient to machine from a metal casting or forging and thereby molding such features integrally within the plastic overmold housing 52 provides reduced costs and increased production efficiencies.

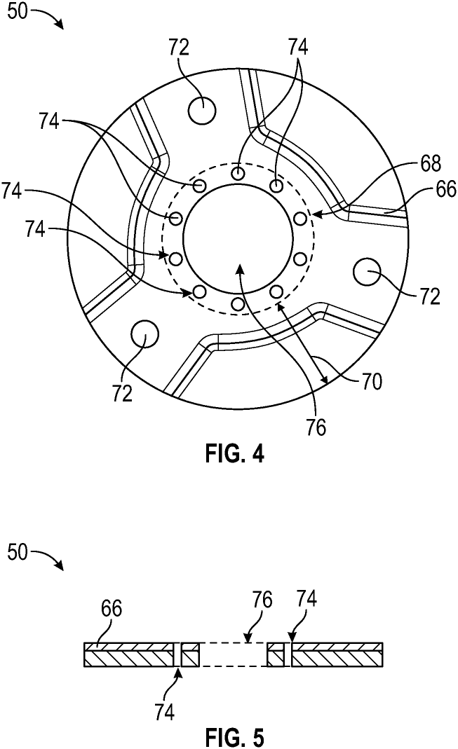

Referring to FIGS. 3, 4 and 5 with continued reference to FIG. 2, the metal flange 50 includes a center portion 68 that is encased within the plastic overmold housing 52. A central opening 76 is provided to correspond with the opening 64 defined through the plastic overmold housing 52. In one disclosed example, the metal flange 50 is disposed within the plastic overmold housing 52 in a center space 55 between the top cavity 56 and the bottom cavity 58.

A plurality of openings 74 are provided in the center portion 68 to provide for plastic flow through the metal flange 50 during overmolding. The openings 74 are arranged to provide desired plastic flow during an overmolding process. Cured and solidified plastic material within a through the openings 74 secure the metal flange within the plastic overmold housing 52 once the top cap 26 is completed.

Ribs 66 extend outward from the center portion 68 into an outer portion 78 that radially surrounds the center portion 68. The ribs 66 provide an increased structural rigidity to accommodate loads encountered during operation. Openings 72 are provided in the outer portion 70 to accommodate the studs 54.

Although the example metal flange 50 is shown as a circular plate, other shapes could be utilized and are within the contemplation and scope of this disclosure. The metal flange 50 could be of any curvilinear or rectilinear shape or a complex shape that corresponds to vehicle mounting structures. Moreover, the metal flange 50 may be flat and/or have curves to conform to a desired shape of the plastic overmold housing 52.

In one disclosed example, the metal flange 50 is formed from a steel that is coated to inhibit corrosion. The specific steel material may be of any grade that provides the desired structural properties to transfer loads for a desired operational life cycle. Additionally, other metal materials and composites that are compatible with overmolding processes could also be utilized and are within the scope and contemplation of this disclosure.

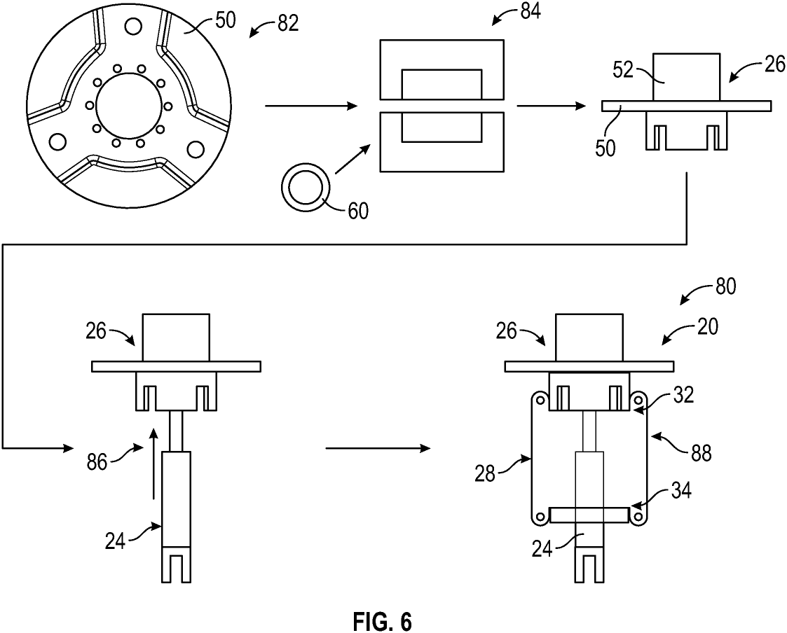

Referring to FIG. 6, a method of assembling an air spring strut 20 is schematically shown and indicated at 80. The example process includes the step 82 of forming the metal flange 50. The metal flange 50 may be formed using any metal forming process. In one disclosed example, the metal flange 50 is formed as a stamping. The support ring 60 is also formed using known metal fabrication processes.

The metal flange 50 and the support ring 60 are than placed in a mold and overmolded as schematically indicated at 84. The metal flange 50 is secured within a cavity defined by the mold that provides the desired shape of the completed plastic overmold housing 52. The metal flange 50 includes the opening 74 that aids the molding process by defining passageways for the flow of molten plastic material. The molten plastic material flows through the openings 74 in the metal flange to improve molding consistency and efficiency. Additionally, plastic that is cured and hardened within the openings 74 secure the metal flange 50 within the plastic overmold housing 52.

The completed top cap 26 is thereby essentially an integrated part with the metal flange 50 providing features for mounting to a motor vehicle and bearing load and the plastic overmold housing 52 providing more complex shapes that do not bear a load but that are critical to operation and durability. Such features include the crimp surfaces 62 as well as features integrally included within the top cavity 56 and the bottom cavity 58.

One the top cap 26 is complete, the shock absorber 24 is assembled to the top cap 26 as indicated at 86. The shock absorber 24 is attached by extending the piston rod 30 into the top cavity 56. The piston rod 30 is then secured to the damper bushing 42 by a nut 44 as is best shown in FIG. 1. Other parts are assembled to the top cap 26 that include the bumper 40 and any other components that are disposed within the bellows 28.

Assembly is completed as indicated at 88 by attaching any additional components to the shock absorber 24 and top cap 26. The final assembly indicated at 88 includes attaching the bellows 28 to the top cap 26 at the first end 32. The second end 34 of the bellows 28 is then attached to a portion of the shock absorber 24.

The metal flange 50 and plastic overmold housing 52 that form the one integral top cap 26 reduces the time and costs associated with producing an air spring strut 20. Moreover, the disclosed top cap 26 provides for a reduction in weight while retaining structural features and durability.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An air spring strut for a motor vehicle comprising:
a shock absorber;
a top cap is an overmolded metal flange extending from a plastic overmold housing, wherein the metal flange is configured for attachment to a frame member of a motor vehicle and the plastic overmold housing configured for receiving a damper bushing; and
a bellows including a first end clamped to the plastic overmold housing of the top cap and a second end attached to a portion of the shock absorber, the bellows defining a working space filled with air and forming a rolling fold that rolls on the top cap and the shock absorber.

2. The air spring strut as recited in claim 1, wherein the plastic overmold housing defines a top cavity, a bottom cavity and an opening extending therebetween for a piston rod of the shock absorber.

3. The air spring strut as recited in claim 2, wherein a center portion of the metal flange is disposed within the plastic overmold housing between the top cavity and the bottom cavity.

4. The air spring strut as recited in claim 3, wherein an outer portion of the metal flange extends outward from the center portion and outward from the plastic overmold housing.

5. The air spring strut as recited in claim 4, wherein the center portion of the metal flange includes at least one opening and plastic material of the plastic overmold housing is disposed within the at least one opening for securing the metal flange within the plastic overmold housing.

6. The air spring strut as recited in claim 2, wherein the bottom cavity is configured to receive and hold a bumper to limit movement and absorb energy from the shock absorber.

7. The air spring strut as recited in claim 2, wherein the top cavity includes an integrally molded inner groove for receiving a retaining ring to secure a closure cap to the top cap.

8. The air spring strut as recited in claim 1, wherein the metal flange includes a plurality of outwardly extending ribs that extend outward from the plastic overmold housing.

9. The air spring strut as recited in claim 1, including at least one metal fastening member secured to the metal flange.

10. The air spring strut as recited in claim 1, including a support ring partially overmolded within the plastic overmold housing, the support ring formed from a metal and is disposed radially inward of a crimp surface for the first end of the bellows.

11. A top cap assembly for an air spring strut, the top cap assembly comprising:
an overmolded metal flange extending outwardly from a plastic overmold housing, wherein the metal flange is configured for attachment to a frame member of a motor vehicle and the plastic overmold housing configured for receiving a damper bushing.

12. The top cap assembly as recited in claim 11, wherein the plastic overmold housing defines a top cavity, a bottom cavity and an opening extending therebetween.

13. The top cap assembly as recited in claim 12, wherein a center portion of the metal flange is disposed within the plastic overmold housing between the top cavity and the bottom cavity.

14. The top cap assembly as recited in claim 13, wherein an outer portion of the metal flange extends outward from the center portion and outward from the plastic overmold housing.

15. The top cap assembly as recited in claim 14, wherein the center portion of the metal flange includes at least one opening and plastic material of the plastic overmold housing is disposed within the at least one opening for securing the metal flange within the plastic overmold housing.

16. A method of assembling an air strut assembly comprising:
forming a metal flange to include attachment features configured for securement to a frame member of a motor vehicle;
forming a top cap assembly by overmolding the metal flange into a plastic overmold housing such that features of the metal flange configured for securement to the motor vehicle extend outside of the plastic overmold housing;
assembling a shock absorber assembly to the top cap assembly; and
assembling a first end of a bellows to the top cap and a second end of the bellows to a portion of the shock absorber, the bellows defining a working space filled with air and forming a rolling fold that rolls on the top cap and the shock absorber.

17. The method as recited in claim 16, wherein forming the top cap assembly further includes overmolding a support ring partially within the plastic overmold housing and radially inward of a crimp portion formed of the plastic material of the plastic overmold assembly.

18. The method as recited in claim 17, including forming the metal flange to include rib portions extending radially outward from a center portion, wherein the attachment features are disposed on the rib portions.

19. The method as recited in claim 18, wherein the center portion of the metal flange is formed to include at least one opening and forming the top cap assembly includes overmolding the metal flange such that plastic material of the plastic overmold housing is disposed within the at least one opening for securing the metal flange within the plastic overmold housing.

20. The method as recited in claim 16, wherein assembling the shock absorber to the top cap assembling further includes assembling a damper bushing into a top cavity of the top cap and extending a piston rod of the damper through an opening in the top cap into the top cavity and attaching the piston rod to the damper bushing.
